(19) United States
(12) Patent Application Publication
(10) Pub. No.: US 2021/0065018 A1
(43) Pub. Date: Mar. 4, 2021

(54) Smart Question and Answer Optimizer

(71) Applicant: INTUIT INC., Mountain View, CA (US)

(72) Inventors: Igor A. PODGORNY, San Diego, CA (US); Faraz SHARAFI, Poway, CA (US); Leslie M. CAHILL, Grapevine, TX (US)

(21) Appl. No.: 16/552,002

(22) Filed: Aug. 27, 2019

(51) Int. Cl. G06N 5/04; G06N 20/00

(52) U.S. Cl. CPC G06N 5/04; G06N 20/00

(57) ABSTRACT

Certain aspects of the present disclosure provide techniques for providing assistance to users within a social computing environment to generate questions and answers. In some cases, a user can opt to have a question optimizer generate a question based on the input the user has provided. In other cases, the user can opt to have an answer optimizer generate an answer based on the user provided input. Each optimizer includes a generative model trained with deep learning and artificial neural network to translate the user input with, for example, a long short-term memory model. The generated question and/or answer is displayed to the user in an interactive user interface and posted by the user to the social computing environment.

### INTRODUCTION

Aspects of the present disclosure relate to a method and system for generating questions and answers to assist users in a social computing environment based on deep generative models.

### BACKGROUND

Social computing environments are interactive and foster collaboration between users and promote innovation. Organizations can implement social computing environments for such reasons as well as to provide assistance to users, such as in the form of support services, for products and/or services offered by that organization. However, some users struggle with articulating questions within the social computing environment. For example, a user may not be familiar with key terminology, lack search skills, and other similar shortcomings resulting in poorly phrased questions posted to the social computing environment. Additionally, users who have trouble writing their questions for the social computing environment may contact live support agents for assistance on how to phrase their questions in order to find the answer. This is an additional strain on resources for the organization as a live support agent is likely better suited to solve the problem rather than help phrase the question. Further, such a call to a live support agent at least in part defeats the purpose of the social computing environment, which is to provide users with a way to obtain answers to their questions without contacting a live support agent.

At the same time, other users who are answering questions within the social computing environment can fail to understand the question (e.g., a poorly phrased question), the user can lack the writing skills to effectively communicate the answer, and other similar short comings that results in a poorly phrased answer or an answer that fails to properly address the issue(s) raised in the question. The posting of poorly phrased questions and answers is a waste of an organization's resources as time, money, and effort is not focused on finding solutions for users but instead focused on trying to understand what the questions and answers are as well as manually re-phrasing the questions and answers to communicate effectively within the social computing environment. Further, poorly phrased questions and answers within an organization's social computing environment negatively impacts the organization as a whole, as the organization can be seen as ill-equipped to effectively assist users through the social computing environment. This can result in additional calls to live support agents, which the social computing environment was intended to reduce.

As such, a solution is needed to provide assistance to users for phrasing questions and answers for effective communication within the social computing environment.

### BRIEF SUMMARY

Certain embodiments provide a method for providing assistance to users of a social computing environment. The method generally includes receiving input of a question from a first user in real time. The method further includes determining, based on the input, a quality of the question from a first set of content management algorithms. The method further includes prompting the first user with a notification for assistance in generating the question. The method further includes receiving a request from the first user for assistance. The method further includes generating a new question with a first generative model. The method further includes providing the generated question to the first user. The method further includes receiving confirmation from the first user to post the generated question. The method further includes posting the generated question to a social computing environment.

Other embodiments provide systems configured to perform the aforementioned method for providing assistance to users of a social computing environment, as well as non-transitory computer-readable storage mediums comprising instructions that, when executed by a processor of a social computing system, causes the social computing system to perform methods for providing assistance to users of a social computing environment.

The following description and the related drawings set forth in detail certain illustrative features of one or more embodiments.

### BRIEF DESCRIPTION OF THE DRAWINGS

The appended figures depict certain aspects of the one or more embodiments and are therefore not to be considered limiting of the scope of this disclosure.

FIG. 1 depicts an example social computing system for providing assistance to a user interacting within the social computing environment according to an embodiment.

FIG. 2A depicts an example flow diagram of the training of a generative model for generating a question for assisting a user in the social computing environment according to an embodiment.

FIG. 2B depicts an example flow diagram of the training of a generative model for generating an answer for assisting a user in the social computing environment according to an embodiment.

FIGS. 3A-3C depict example user interfaces displayed to provide assistance to a user for generating questions according to an embodiment.

FIGS. 4A-4B depict example user interfaces displayed to provide assistance to a user for generating answers according to an embodiment.

FIG. 5 depicts an example user interface displayed to provide assistance to a user with special privileges for generating answers according to an embodiment.

FIG. 6 depicts an example user interface displayed to a user with an answer to the question posted in the social computing environment according to an embodiment.

FIG. 7 depicts a flow diagram for generating a question to post in the social computing environment according to an embodiment.

FIG. 8 depicts a flow diagram for generating an answer to post in the social computing environment according to an embodiment.

FIG. 9 depicts an example server in the social computing system for providing assistance to users for generating questions and answers according to an embodiment.

To facilitate understanding, identical reference numerals have been used, where possible, to designate identical elements that are common to the drawings. It is contemplated that elements and features of one embodiment may be beneficially incorporated in other embodiments without further recitation.

### DETAILED DESCRIPTION

Aspects of the present disclosure provide apparatuses, methods, processing systems, and computer readable mediums for providing assistance to users of a social computing environment (e.g., a social computing system) by generating questions and answers using generative question and generative answer models, respectively.

An organization can implement a social computing system to provide support for a product and/or service offered by the organization. A social computing system can provide to users an interactive user interface. Users of the social computing system can view generated content (e.g., questions and answers) or generate their own content that is related to a product and/or service of the organization with the interactive user interface. In one embodiment, a user with a question can access the social computing system and request to post a question to the social computing system via the interactive user interface provided. As the user begins to type in their question, the user may have difficulty articulating their question.

To assist the user, a generative question model of a question optimizer can generate a question for the user to post in the social computing environment based on a real time analysis of the question input provided. For example, a user can have a question about a product offered by the organization. As the user begins to enter their question (e.g., question input data), the social computing system determines in real time the quality of the question input. In some cases, a set of content management algorithms are deployed, which include a low-quality classifier, a misplaced question classifier, a spam detection algorithm, a rant detection algorithm, a garbage detection algorithm, and a homoglyph detection model. By determining the quality of input entered, the question optimizer of the social computing system can provide a prompt (or notification) to a user for assistance in generating their question. In some cases, the prompt can be provided with the interactive user interface and be available to the user to select once the user begins to enter the question. In other cases, the social computing system can block a question based on the quality.

Upon receiving confirmation from a user for assistance, a first deep generative model (e.g., a generative question model) generates a question by transforming the question input to a well-articulated question using deep learning algorithms (e.g., long-short term memory models) and artificial neural networks (e.g., recurrent neural network and generative adversarial network). For example, the generative question model can generate the question “Can I deduct repairs I made in the house I just bought?” from question input “Why cant I deduce house fixes for new house.” The artificial neural network for creating the generative question model is trained with data from within the social computing environment (e.g., posts, replies, click stream, user and vote tables, etc.) and implemented using a deep learning library (e.g., PyTorch, TensorFlow™, Caffe, Keras, Microsoft Cognitive Toolkit). For example, in some cases, training of the generative question model includes pairing high quality questions with low quality questions. A high quality question is one that has been validated by a trusted user of the social computing system (e.g., an employee of the organization), and a low quality query is one that has not been validated by a trusted user.

The user can review the generated question in the interactive user interface. If the user is satisfied with the question generated, then the user can post the question to the social computing environment. By doing so, the user validates the question, which is logged for continuous training of the generative question model. If the user is not satisfied with the question generated, then the user can provide such indication to the social computing system, which is also logged for training the generative question model.

In another embodiment, a user can access the social computing system to answer a question. In some cases, the user can be a customer, potential customer, technical expert, or an employee of the organization. A trusted user is a user with authorized privileges in the social computing environment (e.g., to remove duplicate questions from the social computing system or to re-phrase a posted question or answer). For example, an employee can be a trusted user. In another example, a customer or technical expert that has consistently provided quality answers to questions posted can be granted authorized privileges as a trusted user in the social computing environment.

Once a user has selected a question to answer, the social computing system can determine in real time, based on the answer input, the quality of the answer. In some cases, a set of content management algorithms for the answer input can be implemented to determine the quality of the answer. For example, the set of content management algorithms for the answer input can include a spam detection algorithm, a garbage detection algorithm, an empty answer classifier, an unfinished answer classifier, and a phone number detection algorithm. As another example, the content management algorithms for the answer can generate a quality score that can be used interactively with the answer optimizer. After the social computing system determines the quality of the answer, a notification (or prompt) can be provided to the user for assistance in generating the answer.

Upon receiving confirmation from the user for assistance, a second deep generative model (e.g., a generative answer model) of an answer optimizer can generate an answer for the user based on the answer input using deep learning algorithms (e.g., long short-term memory models) and artificial neural networks. For example, the generative answer model can generate the answer “In order to access your tax returns, you will need to sign back into your account, select My Tax Timeline, select the tax year you want, and select ‘Download tax returns’” from the answer input “Sign into your account and download the tax return from your account.” The artificial neural network for creating the generative answer model, similar to the generative question model, is trained with data from within the social computing environment (e.g., posts, replies, click stream, user and vote tables, etc.) and implemented using deep learning libraries (e.g., PyTorch, TensorFlow™, Caffe, Keras, Microsoft Cognitive Toolkit). In some cases, the generative answer model can re-phrase a user's answer input, provide automated answers to common questions, and provide customized answer tips. For users without authorized privileges, the answer optimizer can detect early a potential user to be granted trusted user status by monitoring the answer quality metrics. For trusted users, the answer optimizer can generate answer templates for the trusted user when answering a question or provide automatically generated answer snippets. Additionally, validation by trusted users of the generated answers and posted questions can be logged for on-going training of the generative question model and the generative answer models.

The user can review the generated answer in the interactive user interface. If the user is satisfied with the answer, then the user can post the answer in the social computing system. If the user is not satisfied, then the user generate their own answer to post to the social computing system. In some cases, the user can edit the generated answer provided. The social computing system logs how the user handles the generated answer for training purposes of the generative answer model in order to improve how the generative answer model generates answers. In some cases, users can provide feedback about their experience with the question optimizer and/or the answer optimizer. The feedback received is shared by both the question optimizer and the answer optimizer in order to improve how each interacts with the user.

Example Social Computing System for Providing Assistance to Users

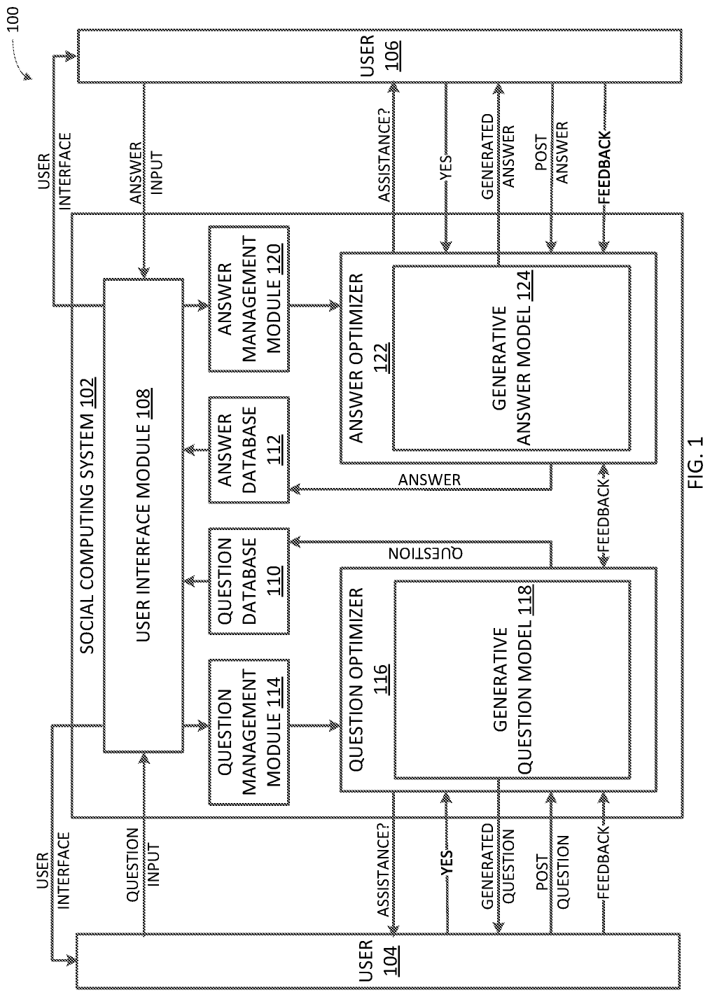

FIG. 1 depicts a social computing environment 100 in which a social computing system 102 provides assistance to users (e.g., user 104 and user 106) in generating questions and answers. A social computing system 102 can establish the social computing environment in which users interact with each other to promote innovation and foster collaboration. In some cases, the social computing system 102 is for online support in which users can post questions to other users about a product and/or service and receive an answer back from other users. In some cases, users 104 and 106 can include technical experts familiar with the product and/or service associated with the social computing environment 100, customers, potential customers, vendors, suppliers, or employees of any organization supporting the social computing system 102.

In one embodiment, a social computing system 102 can provide a user interface to a user 104 and user 106 via the user interface module 108. The user interface is generated by the user interface module 108 and is an interactive user interface in which the users 104 and 106 can search and explore the content of the social computing system 102, such as questions and answers posted in the question database 110 and answer database 112. The users 104 and 106 can browse through the content in the social computing system 102. In some cases, the user 104 cannot find the content the user 104 is looking for. For example, the user 104 may lack the search skills to find a particular answer, or the answer they are looking for does not exist. In such cases, the user 104 can indicate to the social computing system 102 that they would like to post a question. Upon receiving an indication to post a question, the user interface provided by the user interface module 108 can present to the user 104 a text box to enter the question.

As the user interface module 108 receives the question input from the user 104, the question input is provided to a question management module 114 of the social computing system 102. The question management module 114 determines the quality of the question input based on a set of content management algorithms through real time analysis. For example, the content management algorithms for evaluating the question input can include a low-quality question classifier, a misplaced question classifier, a spam detection algorithm, a rant detection algorithm, a garbage detection algorithm, and/or a homoglyph detection model. In some cases, if the question management module 114 determines the question input is spam or a rant, the social computing system 102 can block the user 104 from continuing to enter text. Additionally, the question management module 114 can include a question deduplication algorithm and a question intent detection algorithm. By determining the quality of the question input, the question management module 114 can signal a question optimizer 116 that the user 104 may need assistance in generating the question. In some cases, the quality of the question may be good, but the question optimizer 116 can still be signaled to assist the user 104 in order to generate and post questions efficiently.

Upon receiving the signal from the question management module 114 that the user 104 may need assistance, the question optimizer 116 can generate a prompt and send the prompt as a notification to the user 104. The prompt can be displayed to the user 104 in the user interface and can ask the user if they would like assistance in generating the question (e.g., “Would you like us to re-phrase your question for better results?” or “Let us help you re-phrase your question to help you get the best answer.”). In some cases, the prompt can be provided and available to the user 104 when the user 104 enters question input data to the user interface.

If the user 104 selects “Yes” or indicates in any suitable form that they would like assistance in generating a question, the question optimizer 116 generates a new question for the user, or more specifically, a generative question model 118 of the question optimizer 116 generates the question. The generative question model 118 can generate a question for the user by transforming the question input from the user 104 into a better articulated question. For example, the generative question model 118 can generate the question “Can I deduct repairs I made in the house I just bought?” from question input “Why cant I deduce house fixes for new house.”

The generative question model 118 can generate a question for the user 104 by using long-short-term memory models and artificial neural networks. The generative question model 118 is developed by an artificial neural network (e.g., recurrent neural network and generative adversarial network) of deep learning, which can train the generative question model 118 to generate a question based on previously collected data by the social computing system 102 (e.g., training data). For example, a sequence to sequence (or seq2seq) network in which there are two recurrent neural networks can transform one sequence (e.g., question input data) to another sequence (e.g., new generated question). In such cases, the two recurrent neural networks can include an encoder network that condenses input (e.g., question input data) into a vector and a decoder network that unfolds the vector into a new sequence (e.g., the new generated question). Examples of the deep learning libraries for implementing the long short-term memory models include at least PyTorch, TensorFlow™, Caffe, Keras, and Microsoft Cognitive Toolkit. In some cases, an attention mechanism can be implemented to focus on a specific range of an input sequence.

Once the question is generated by the generative question model 118, the question is provided to the user 104 for review. For example, the question is displayed in the user interface for the user 104 to consider. If the user 104 is satisfied with the question that is generated, then the user 104 can select to post the question in the social computing system 102. For example, the user 104 can select “Post question” in the user interface. In some cases, the user can edit the generated question provided.

Upon receiving the indication from the user 104 to post the question, the question optimizer 116 can post the question to the social computing system 102 and save the question in the question database 110 for other users to review and answer. If the user 104 is not satisfied with the generated question, then the user 104 can continue to enter and post their question, which is then saved to question database 110. Regardless of whether the user 104 selects to post the question generated by the generative question model 118 or their question, the question optimizer 116 logs each action taken by the user for on-going training of the generative question model 118. Similarly, in some cases, if the user 104 opts out of assistance in generating the question, then the opt out and question posted by the user 104 are logged for training the generative question model 118.

Additionally, in some cases, the question optimizer 116 can determine a set of questions in the question database 110 are similar to the generated question. For example, the question optimizer 116 can determine a question is similar to the generated question based on similarity models (e.g., word embedding with Word2Vec models). After determining a similar question, the question optimizer 116 can determine whether the similar question has a corresponding answer. For example, the question optimizer 116 can check the answer database 112 to identify answers associated with the similar question in the question database 110 (e.g., based on a matching identifier of the similar question and answer). Once the question optimizer 116 determines there is an answer for the similar question, the question optimizer 116 can provide the similar question and answer to the user 104 for consideration. If the user 104 is satisfied that the answer to the similar question answers their question, then the user 104 can select to review the answer and not post the generated question. If the user 104 is not satisfied with the similar question and corresponding answer, then the user 104 can elect to post the generated question. Either the selection of the similar question or posting the generated question is logged for further training of the generative question model 118.

In another embodiment, a user 106 is browsing the content of the social computing system 102 via the user interface provided by the user interface module 108 and identifies a question (e.g., the question posted by user 104) in the social computing system 102 to answer. In order to answer the question, the user 106 can select the question via the user interface. The user interface can present a text box to user 106 upon receiving the selection of the question. The user 106 can enter answer input data to the text box in the user interface.

As the user 106 is inputting the answer to the text box, an answer management module 120 can analyze the answer input in real time to determine the quality of the answer. For example, the answer management module 120 can include models and classifiers for flagging unwanted answers such as a phone number disguised with homoglyph characters, comment-type answers, question-type answers, spam, rants, garbage, empty answers, and unfinished answers. In order to detect and flag the unwanted answers, the models and classifiers can be trained on AnswerXchange data or other database containing questions and/or answers for a product, service, or topic of interest. After determining the quality of the answer input, the answer management module 120 can signal to the answer optimizer 122 that the user 106 may need assistance in generating the answer (e.g., an empty answer or an unfinished answer). Even if the quality of the answer input is good, the answer optimizer 122 can still be signaled to assist the user 106 in generating a quality answer quickly. In some cases, if the answer is an unwanted answer (e.g., spam or an empty answer), then the social computing system 102 can block the user 106 from entering text into the text box.

Upon receiving a signal from the answer management module 120, the answer optimizer 122 can generate a prompt and send the prompt as a notification to the user 106. The prompt can be displayed to the user 106 in the user interface and can ask the user if they would like assistance in generating the answer (e.g., “Would you like us to re-phrase your answer?” or “Let us help you re-phrase your answer.”). In some cases, the prompt for assistance can be included with the user interface and available for the user 106 to select when the user 106 enters text into the user interface.

If the user 106 opts for assistance, then the generative answer model 124 of the answer optimizer 122 generates an answer for the user 106. The generative answer model 124 can generate an answer for the user 106 by transforming the answer input using long short-term memory models. The generative answer model 124 (similar to the generative question model 118) is a deep learning model that includes algorithms such as a long short-term memory model for modeling high level of data abstractions using hierarchal or layered model architectures for non-linear transformation of data. As such, deep learning algorithms can apply nonlinear transformations on input (e.g., user question input and user answer input) and iteratively process the input and knowledge generated at a previous layer until an acceptable output is generated (e.g., generated question, generated answer, etc.). For example, the generative answer model 124 can transform answer input “Sign into your account and download the tax return from your account” to an answer such as “In order to access your tax returns, you will need to sign back into your account, select My Tax Timeline, select the tax year you want, and select ‘Download tax returns.’”

In order for the generative answer model 124 to generate an answer based on the answer input, the generative answer model 124 is created using an artificial neural network trained to generate the answer based on training data. For example, a sequence to sequence network that includes two recurrent neural networks (e.g., an encoder network and a decoder network) can be implemented to transform the user input (e.g., answer input data) into a new answer. The artificial neural network (e.g., recurrent neural network) can train a generative answer model 124 based on data previously collected by the social computing system 102 (e.g., posts, replies, user tables, vote tables, click streams, etc.). The training data set to train the generative answer model 124 is different than the training data set to train the generative question model 118. For example, the training data set for the generative answer model 124 is associated with answers in the social computing system 102, and the training data set for the generative question model 118 is associated with questions in the social computing system 102. Examples of the deep learning libraries for implementing the long short-term memory models include at least PyTorch, TensorFlow™, Caffe, Keras, and Microsoft Cognitive Toolkit.

Once the answer is generated, the answer is provided to the user 106 for review. In some cases, the generative answer model 124 can generate more than one re-phrased answer with corresponding quality scores to provide to the user 106. In such cases, the re-phrased answers can be sorted according to the corresponding scores. If the user 106 is satisfied with the answer, the user 106 can select to post the answer. After receiving the selection from the user 106 to post the answer, the answer optimizer 122 adds the answer to the answer database 112. In some cases, the user 104 that initially posted the question can then see the answer posted in their user interface. After the user 106 selects to post the answer, the selection of the answer also validates the answer, and the validation can be logged by the answer optimizer 122 for on-going training of the generative answer model 124. If the user 106 is not satisfied with the generated answer, the user 106 can continue generating their own answer to post to the social computing system 102. In some cases, the user can edit the generated answer provided and post the modified answer to the social computing system 102.

In some cases, in addition to re-phrasing the answer input, the answer optimizer 122 can provide automated answers to common questions and provide customized answer tips to user 106. For example, the answer optimizer 122 can determine an answer corresponding to the posted question exists in the answer database 112 (e.g., by matching identifiers). In another example, the answer optimizer 122 can match the posted question to a question in a list of common questions and provide to the user 106 the corresponding answer. The user 106 can either accept or reject the automated answer and customized answer tips, and the action taken by the user 106 is logged for training the generative answer model 124. Similarly, if the user 106 opts out of assistance from the answer optimizer 122 in generating the answer, the answer optimizer 122 can log this instance for training.

In some cases, the user 106, who answers questions in the social computing system 102, is a trusted user. A trusted user of the social computing system 102 is a user with authorized special privileges and can be an employee, a technical expert, or a customer that has consistently provided quality answers to questions. The answer optimizer 122 can provide a trusted user answer templates when answering a question or provide automatically generated answer snippets. The authorized special privileges of the trusted user also include editing automated answers, removing duplicate questions from the social computing system 102, and editing a question that has been posted in the social computing system 102.

Additionally, the answer optimizer 122 can monitor a user's answer quality metrics (e.g., readability score, accuracy score, number of up votes, number of likes, etc.) and detect a potential trusted user from the answers provided by that user. For example, if a customer consistently provides answers, resulting in high quality metrics, the answer optimizer 122 can send a notification to a moderator of the social computing system 102 (e.g., a trusted user associated with the organization that established the social computing system 102). In some cases, a readability score can be generated by Fleisch-Kincaid readability score formula or a SMOG index formula, and the accuracy score can be calculated based on a model trained using accuracy scores provided by trusted users. In other cases, answer management module 120 can generate a quality score ranging from 0.0 to 1.0. In such cases, the algorithm for calculating the quality score is trained using a data set of answers scored by trusted users and/or by user votes or feedback. The numeric quality score generated can be used interactively with the answer optimizer. The notification to the moderator can indicate that the user is a potential trusted user for consideration to be granted authorized special privileges within the social computing system 102.

In some cases, the user 104 and the user 106 can provide feedback about their experience with the question optimizer 116 and the answer optimizer 122. Further, the users 104 and 106 can provide feedback about the generated question and answer. All of the feedback provided by the users 104 and 106 are shared between the question optimizer 116 and the answer optimizer 122 for improving how both operate going forward in the social computing system 102.

Example Flow Diagram for Training a Generative Model to Generate a Question

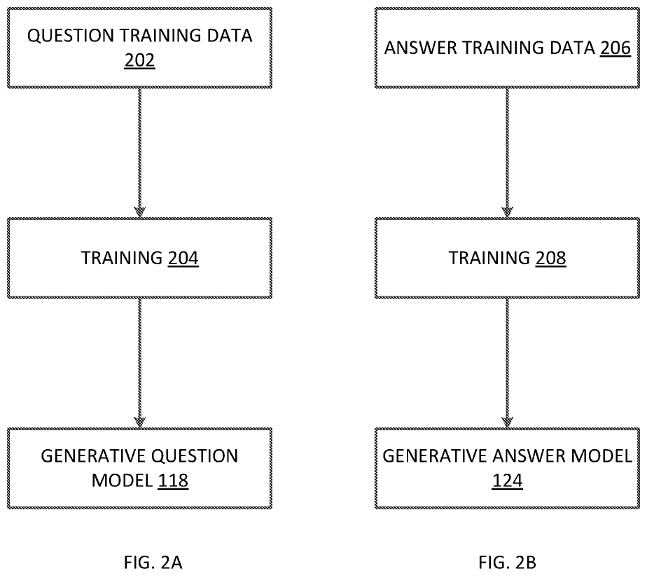

FIG. 2A depicts an example flow diagram of training a generative model (e.g., a generative question model) that generates a question for users, as described in FIG. 1.

The generative question model 118 is a deep learning model (e.g., long short-term memory model) based on, in some cases, an artificial neural network (e.g., a recurrent neural network, a generative adversarial network, etc.). The generative question model 118 can transform user question input to generate a new, re-phrased question that has a quality matching a question validated by a trusted user. In some cases, the machine learning libraries like PyTorch, TensorFlow™, Caffe, Keras, Microsoft Cognitive Toolkit, etc. can be used to develop the deep learning model.

In order to train the generative question model 118 to generate a question based on question input from a user, the artificial neural network initially trains the generative question model 118 using question training data 202 from the social computing environment and deep learning algorithms. The social computing environment provides a large amount of data for the generative question model 118 to train on in order to be able to generate accurate questions. In some cases, the training of the generative question model 118 is unsupervised. For example, the question training data 202 can include posts, replies, user tables, vote tables, and click streams associated with questions. With the question training data 202, the artificial neural network can train 204 a generative question model to generate a question for user.

In some cases, training 204 of the generative question model 118 includes pairing high quality questions with low quality questions. A high quality question is one that has been validated by a trusted user of the social computing system (e.g., an employee of the organization), and a low quality question is one that has not been validated by a trusted user. For example, training the generative question model 118 with a question pairing includes inputting the low quality question (e.g., an input tensor) to recurrent neural networks (e.g., an encoder and decoder), and tracking the output at each layer of the modelling architecture until reaching the target tensor. In such cases, the hidden layer size can be 2000. In other cases, the hidden layer size can be greater or less than 2000. By training the generative question model 118 on the pairings in the artificial neural network, the generative question model 118 when implemented can map the question input to the low quality question and generate a re-phrased question that matches the high quality question.

Additionally, after the initial training and implementation of the generative question model 118, the training 204 of the generative question model 118 continues with feedback and logged actions (e.g., validation of a question, request for a new generated question) from users as part of the training data.

Example Flow Diagram for Training a Generative Model to Generate an Answer

FIG. 2B depicts an example flow diagram of training a generative model (e.g., a generative answer model) that generates an answer for users, as described in FIG. 1.

The generative answer model 124 is a deep learning model (e.g., long short-term memory model) based on, in some cases, an artificial neural network (e.g., a recurrent neural network, a generative adversarial network). The generative answer model 124 can transform user answer input to generate a new, re-phrased answer that has a quality matching a validated answer by a trusted user.

In order for the generative answer model 124 to generate an answer from user answer input, an artificial neural network initially trains the generative answer model 124 using answer training data 206 from the social computing system and deep learning algorithms. In some cases, the training of the generative answer model 124 can be unsupervised. For example, the answer training data 206 can include posts, replies, user tables, vote tables, and click streams associated with answers in the social computing system. In some cases, the training data 206 can be unlabeled. The artificial neural network can train 208 with the answer training data 206 to generate an answer for the user. For example, machine learning libraries like machine learning libraries like PyTorch, TensorFlow™, Caffe, Keras, Microsoft Cognitive Toolkit, etc. can be used for developing the generative answer model.

In some cases, training 208 of the generative answer model 124 can be based on pairings of good quality answers with bad quality answers. A good quality answer is an answer that has been generated and/or validated by a trusted user of the social computing system. A low quality answer is an answer that has not been generated and/or validated by a trusted user. By training the generative answer model 124 on pairings in the artificial neural network, the generative answer model 124 can map the answer input received from a user as a low quality answer and generate a re-phrased answer that matches a good quality answer. For example, training of the generative answer model 124 can include inputting the low quality answer (e.g., as the input tensor) to a recurrent neural networks and iteratively tracking the processing of the input tensor through each layer or hierarchal level of the architectural model until meeting the target tensor (e.g., the good quality answer).

Further, after the generative answer model 124 is implemented, the generative answer model 124 is continually trained using feedback and logged user actions with the social computing system as part of the training data.

Example User Interfaces for Providing Assistance to Generate Questions

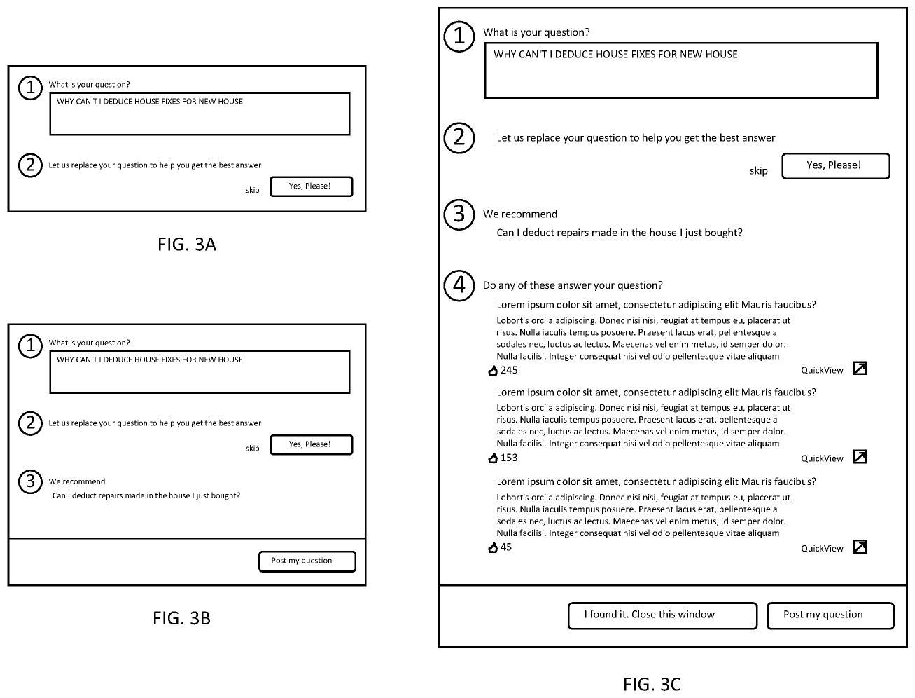

FIGS. 3A-3C depict user interfaces provided to a user for assistance in generating a question.

FIG. 3A depicts a user interface in which a user has entered their question input “Why cant I deduce house fixes for new house.” into a text box. The user interface includes an option for the user to consider letting the question optimizer generate a new question based on the input included in the text box. As depicted, the user interface includes the prompt “Let us replace your question to help you get the best answer.” In some cases, the prompt is provided with the text box and available to the user upon receiving input in the text box. In other cases, the prompt can be provided to the user based on the quality of the user input. For the option of assistance, the user can select either the “Yes, Please!” button or the “Skip” button. The selection of the user is recorded by the social computing system for continual training of the generative question model.

FIG. 3B depicts a user interface in which a user has selected the “Yes, Please!” button. As a result of the selection for assistance, the generative question model of the question optimizer generates a question which is displayed in the user interface. As depicted, a new generated question is displayed to the user in the user interface (e.g., “Can I deduct repairs made in the house I just bought?” The question generated and displayed in the user interface is based on the question input the user provided in the text box. If the user is satisfied with the question displayed, the user can select the “Post my question” button to post the question in the social computing system.

In some cases (not depicted), a user may not be satisfied with the question displayed and as such may continue to enter text into the text box, select “skip” to any assistance from the question optimizer, and post their question to the social computing system. In still other cases (not depicted), a user not satisfied with the question generated can request additional assistance after inputting additional text to the text box and requesting assistance to generate a new question.

FIG. 3C depicts a user interface that is presented to a user that has requested assistance in generating a question. In some cases, the question optimizer can determine the question generated is similar to other questions in the question database (e.g., based on similar keywords in the questions). As such, the question optimizer can display the similar questions in the user interface along with the generated question. In some cases, as depicted, the similar questions may have answers that the question optimizer can retrieve from the answer database and display in the user interface. If one of the similar questions has an answer that resolves the user's question, then the user can select the similar question and review the associated answer. In such cases, the user can select “I found it. Close the window.” If the user does not see an answer associated with the similar questions displayed that answers their question, then the user can choose to post the question with the social computing environment.

Example User Interfaces for Providing Assistance to Generate Answers

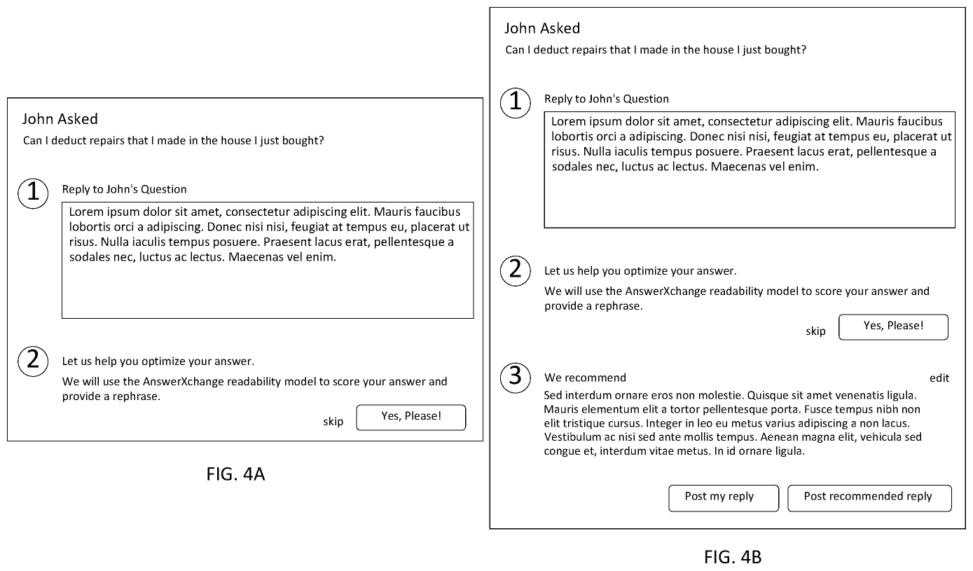

FIGS. 4A-4B depicts user interfaces provided to a user for assistance in generating an answer.

FIG. 4A illustrates a user interface displayed to a user that has selected a question to answer. The user interface, as depicted, includes the question selected and a text box for the user to enter the answer. Also included in the user interface is the option to select assistance in generating the answer. In some cases, the option for assistance is included with the text box and available to the user to select after entering text into the text box. In other cases, the option for assistance appears after determining the quality of the answer input provided in the text box.

FIG. 4B illustrates a user interface displayed to a user that has selected the button “Yes, Please!” in requesting assistance in generating the answer. When the user selects the option for assistance, the answer optimizer evaluates the text in the text box. In some cases, the answer optimizer can generate a readability score (e.g., calculated by Fleisch-Kincaid readability score formula or a SMOG index formula). In other cases, the generative answer model can generate an answer based on the text input in the text box. Once the answer is generated, the answer optimizer can display the generated answer in the user interface (as depicted). If the user is satisfied with the generated answer, then the user can select the “Post recommended reply.” If the user is not satisfied with the generated answer, then the user can select “Post my reply” in which the answer that is in the text box is posted to the social computing system. The selection of either posting the generated answer or their answer is logged for training the generative answer model.

Example User Interface for Providing Assistance to Generate Answers

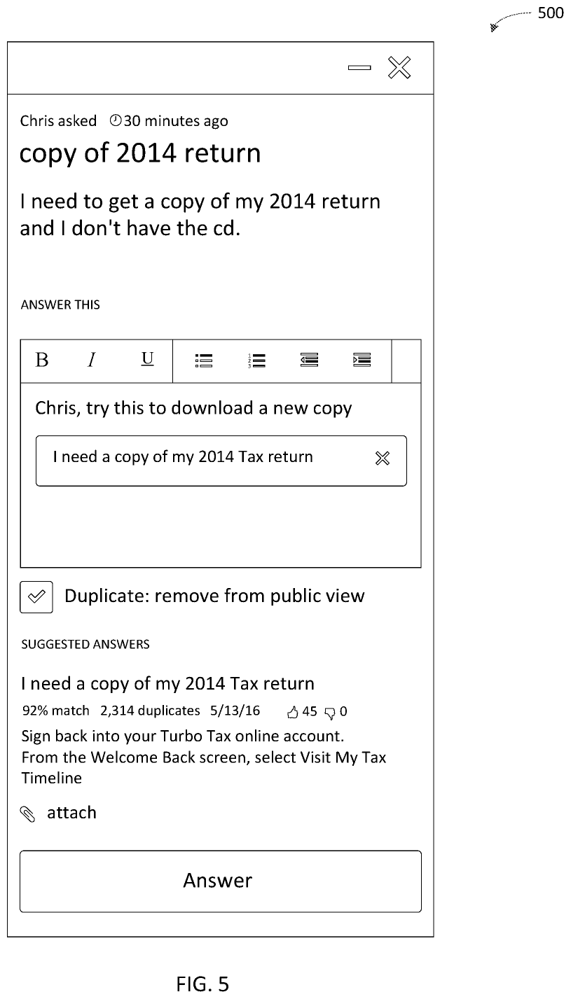

FIG. 5 depicts an example user interface 500 for providing assistance to generate an answer. In some cases, a user answering a question is a trusted user. As such, the trusted user has authorized privileges, reflected in the user interface of the trusted user. For example, the trusted user can receive in the user interface automated answer snippets and can remove a duplicate question from public view (as depicted). In some cases, the trusted user can include links to previously generated answers. Once the user is satisfied with the answer in the text box, the trusted user can select the “Answer” button to post the answer to the social computing system.

Example User Interface Displayed to a User with an Answer to Posted Question

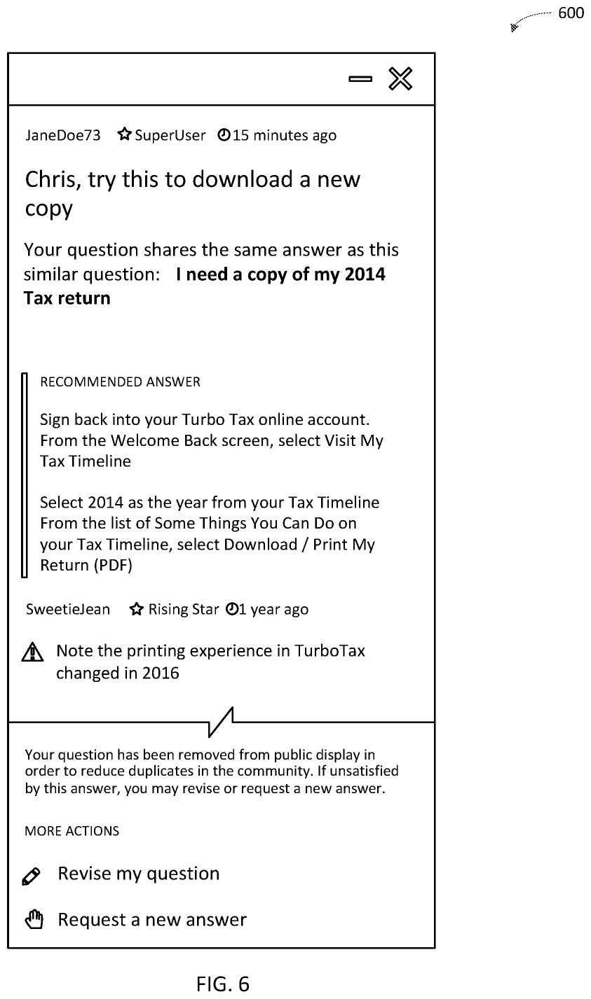

FIG. 6 depicts an example user interface 600 displayed to a user with an answer to the posted question. In some cases, a user can receive an answer in the user interface from the social computing system for their posted question. In some cases, the answer displayed can include a note from another user. For example, trusted users can edit automated answers to include a note for other users viewing the answer, and the note can be included with the answer. In other cases, a notification can be displayed to the user in the user interface that the question posted was a duplicate, and as such the question is removed from public display.

As depicted, the user interface provided to the user includes the option for the user to revise the question posted as well as request a new answer if the answer received does not actually answer the question or the use is not satisfied with the answer. If the user selects one of the actions depicted, the action is logged for training purposes. Further, if the user does not select an action and is satisfied with the answer displayed, then the satisfaction of the user (as indicated by not selecting an action) is also logged for training the generative answer model.

Example Method for Generating a Question

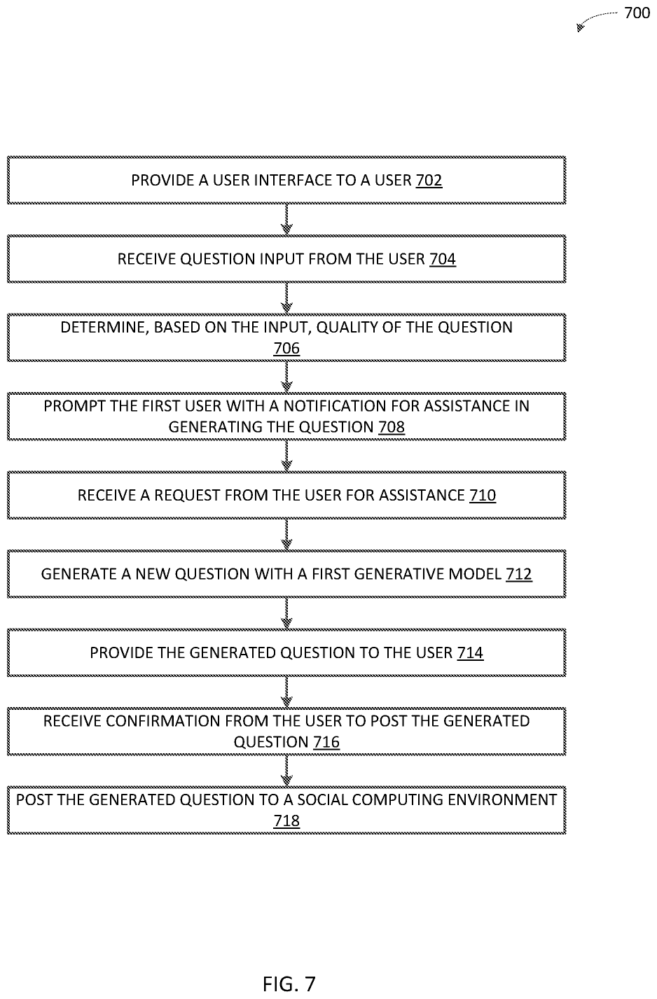

FIG. 7 depicts an example method 700 for providing assistance to a user for generating a question, as described with respect to FIGS. 1, 2, 3A-3C, and 6.

At step 702, a social computing system provides a user interface to a user. The user interface can allow the user to browse and interact with the content that is stored in the social computing environment.

At step 704, the social computing system receives a question input from the user. In some cases, the user can access the social computing system for support assistance regarding a product and/or service. The user can search the social computing system and if the user does not find the answer to their question (e.g., due to a lack of search skills or no answer exists), then the user can request to post a question. By request to post a question, the user interface can provide the user a text box to enter in the question.

At step 706, the social computing system determines the quality of the question based on the input. In some cases, the social computing system can determine the quality of the question in real time as the question input is entered into the text box. For example, a set of content management algorithms for the question can be implemented including low-quality classifier, a misplaced question classifier, a garbage detection algorithm, and a homoglyph detection model. In some cases, the social computing system can block a question based on the results of the content management algorithms. For example, if the garbage detection determines that the question is a set of random keystrokes, then the social computing system block the question. In some cases, the social computing system can provide a notification to the user that the question input provided fails to meet the threshold of question content.

At step 708, the social computing system prompts the user with a notification for assistance in generating the question. In some cases, the prompt can be provided based on a signal from a question management module in the social computing system determining via the set of content management algorithms that the question input is low quality. In other cases, the prompt can be provided with the text box initially provided in the user interface and available for the user to select after entering text to the text box.

At step 710, the social computing system receives a request from the user for assistance. For example, if the user is having trouble articulating the question, then the user can select the option for assistance, sending a signal to the social computing system that the user is requesting assistance in generating the question.

At step 712, the social computing system generates a new question with a generative question model. For example, the generative question model can transform the question input to a question using a long short-term model.

At step 714, the social computing system provides the generated question to the user. For example, the social computing system can display the generated question in the user interface.

At step 716, the social computing system receives confirmation from the user to post the generated question. For example, the user can select the option in the user interface to post the generated question if the user is satisfied with the generated question. In some cases, if the user is not satisfied with the generated question, then the user can modify the generated question to post or post their question to the social computing system.

At step 718, the social computing system posts the generated question in the social computing system. In some cases, the question optimizer can store the generated question in a question database that other users can access through their user interface to view and/or answer.

Example Method for Generating an Answer

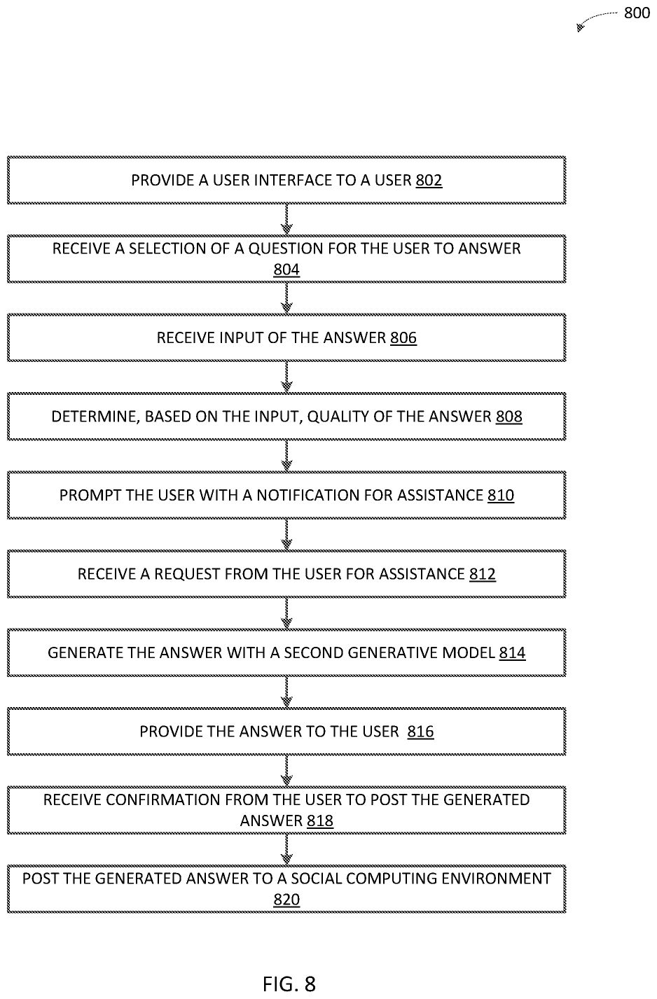

FIG. 8 depicts an example method 800 for providing assistance to a user for generating a question, as described with respect to FIGS. 1, 2, 4A-4B, and 5.

At step 802, the social computing system provides a user interface to a user. The user interface provided to the user can allow the user to browse and interact with the content that is stored in the social computing environment.

At step 804, the social computing system receives a selection of a question for the user to answer. For example, the user can select a question that was posted by another user to answer.

At step 806, the social computing system receives input of an answer. For example, the user can enter text to a text box in the user interface, answering the question selected.

At step 808, the social computing system determines the quality of the answer based on the input. In some cases, the social computing system can determine the quality of the answer in real time as the answer input is entered into the text box of the user interface. For example, the social computing system can include an answer management module for flagging, and in some cases, blocking unwanted answers based on the quality of the answer input. The answer management module can implement a set of content management algorithms, including a spam detection algorithm, a garbage detection algorithm, an empty answer classifier, an unfinished answer classifier, and a phone number detection algorithm. For example, if the spam management detection algorithm indicates the answer input is spam (e.g., based on the content of the answer input), then the social computing system can block the answer from the social computing system. In some cases, the social computing system can provide a notification to the user the answer input is below a required threshold or that the answer is unfinished. In other cases, the social computing system can determine a readability score of the answer input using a readability model.

At step 810, the social computing system prompts the user with a notification for assistance. The prompt for assistance can be displayed in the user interface to the user. In some cases, the prompt can be provided in response to the determined quality of the answer input (e.g., the readability score or detection of unfinished answer). In other cases, the prompt can be provided with the user interface when the user selects a question to answer and available for the user to select after entering text (e.g., answer input data) to the text box.

At step 812, the social computing system receives a request from the user for assistance. For example, the user can select to re-phrase the answer in the text box of the user interface.

At step 814, the social computing system generates the answer with a generative question model. The generative question model can transform the answer input using a long short-term memory model.

At step 816, the social computing system provides the answer to the user. For example, the generated answer can be displayed in the user interface.

At step 818, the social computing system receives confirmation from the user to post the generated answer. For example, if the user is satisfied with the generated answer, then the user can indicate in the user interface to post the generated question. In some cases, if the user is not satisfied with the generated answer, then the user can modify the generated question to post or post their answer to the social computing system.

At step 820, the social computing system posts the generated answer to the social computing system. In some cases, the answer optimizer can store the generated answer in an answer database. In other cases, the social computing system can display the generated answer in the user interface of the user that posted the question.

Example Server in the Social Computing System

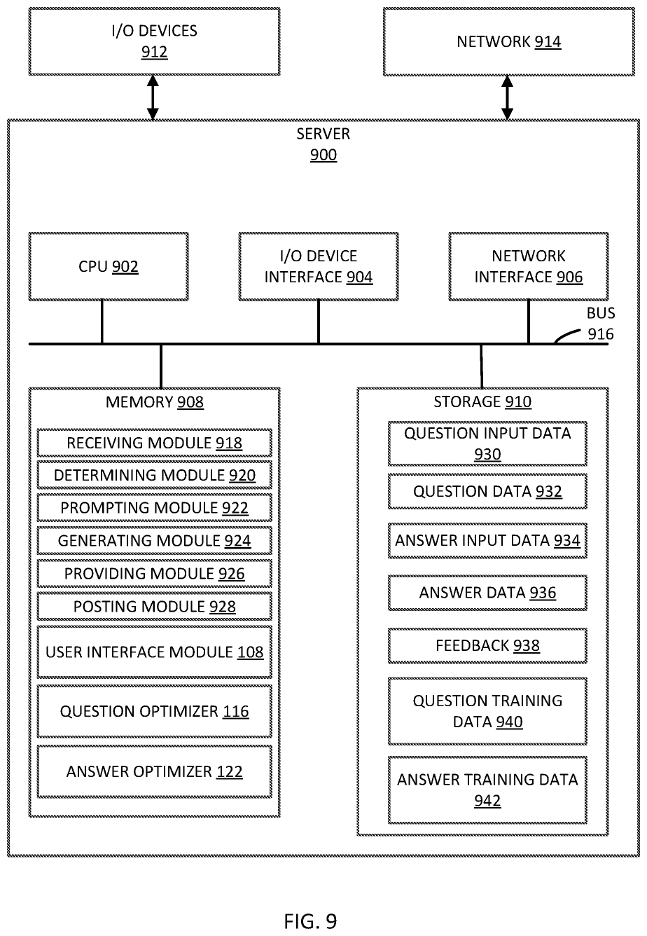

FIG. 9 depicts an example server 900 in the social computing system that may perform methods described herein, such as the method for providing assistance to users in generating questions and answers described with respect to FIGS. 1-8.

Server 900 includes a central processing unit (CPU) 902 connected to a data bus 916. CPU 902 is configured to process computer-executable instructions, e.g., stored in memory 908 or storage 910, and to cause the server 900 to perform methods described herein, for example with respect to FIGS. 1-8. CPU 902 is included to be representative of a single CPU, multiple CPUs, a single CPU having multiple processing cores, and other forms of processing architecture capable of executing computer-executable instructions.

Server 900 further includes input/output (I/O) device(s) 912 and interfaces 904, which allows server 900 to interface with input/output devices 912, such as, for example, keyboards, displays, mouse devices, pen input, and other devices that allow for interaction with server 900. Note that server 900 may connect with external I/O devices through physical and wireless connections (e.g., an external display device).

Server 900 further includes network interface 906, which provides server 900 with access to external network 914 and thereby external computing devices.

Server 900 further includes memory 908, which in this example includes receiving module 918, determining module 920, prompting module 922, generating module 924, providing module 926, posting module 928, user interface module 108, question optimizer 116, and answer optimizer 122 for performing operations described in FIGS. 1-8.

Note that while shown as a single memory 908 in FIG. 9 for simplicity, the various aspects stored in memory 908 may be stored in different physical memories, but all accessible by CPU 902 via internal data connections such as bus 916.

Storage 910 further includes question input data 930, which may be like question input received from a user, as described in FIGS. 1, 3A, 3B, 3C, and 7.

Storage 910 further includes question data 932, which may be like the question generated by the question optimizer, as described FIGS. 1, 3A, 3B, 3C, and 7.

Storage 910 further includes answer input data 934, which may be like answer input received form a user, as described in FIGS. 1, 4A, 4B, and 8.

Storage 910 further includes answer data 936, which may be like the answer generated by the answer optimizer, as described FIGS. 1, 4A, 4B, and 8.

Storage 910 further includes feedback 938, which may be like the feedback provided by users after receiving the generated question from the question optimizer and/or the generated answer from the answer optimizer, as described FIGS. 1, 3A, 3B, 3C, 4A, 4B, and 5-8.

Storage 910 further includes question training data 940, which may be like the question training data, as described in FIG. 2A.

Storage 910 further includes answer training data 942, which may be like the answer training data, as described in FIG. 2B.

While not depicted in FIG. 9, other aspects may be included in storage 910.

As with memory 908, a single storage 910 is depicted in FIG. 9 for simplicity, but various aspects stored in storage 910 may be stored in different physical storages, but all accessible to CPU 902 via internal data connections, such as bus 916, or external connection, such as network interfaces 906. One of skill in the art will appreciate that one or more elements of server 900 may be located remotely and accessed via a network 914.

The preceding description is provided to enable any person skilled in the art to practice the various embodiments described herein. The examples discussed herein are not limiting of the scope, applicability, or embodiments set forth in the claims. Various modifications to these embodiments will be readily apparent to those skilled in the art, and the generic principles defined herein may be applied to other embodiments. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The various illustrative logical blocks, modules and circuits described in connection with the present disclosure may be implemented or performed with a general purpose processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

A processing system may be implemented with a bus architecture. The bus may include any number of interconnecting buses and bridges depending on the specific application of the processing system and the overall design constraints. The bus may link together various circuits including a processor, machine-readable media, and input/output devices, among others. A user interface (e.g., keypad, display, mouse, joystick, etc.) may also be connected to the bus. The bus may also link various other circuits such as timing sources, peripherals, voltage regulators, power management circuits, and other circuit elements that are well known in the art, and therefore, will not be described any further. The processor may be implemented with one or more general-purpose and/or special-purpose processors. Examples include microprocessors, microcontrollers, DSP processors, and other circuitry that can execute software. Those skilled in the art will recognize how best to implement the described functionality for the processing system depending on the particular application and the overall design constraints imposed on the overall system.

If implemented in software, the functions may be stored or transmitted over as one or more instructions or code on a computer-readable medium. Software shall be construed broadly to mean instructions, data, or any combination thereof, whether referred to as software, firmware, middleware, microcode, hardware description language, or otherwise. Computer-readable media include both computer storage media and communication media, such as any medium that facilitates transfer of a computer program from one place to another. The processor may be responsible for managing the bus and general processing, including the execution of software modules stored on the computer-readable storage media. A computer-readable storage medium may be coupled to a processor such that the processor can read information from, and write information to, the storage medium. In the alternative, the storage medium may be integral to the processor. By way of example, the computer-readable media may include a transmission line, a carrier wave modulated by data, and/or a computer readable storage medium with instructions stored thereon separate from the wireless node, all of which may be accessed by the processor through the bus interface. Alternatively, or in addition, the computer-readable media, or any portion thereof, may be integrated into the processor, such as the case may be with cache and/or general register files. Examples of machine-readable storage media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product.

A software module may comprise a single instruction, or many instructions, and may be distributed over several different code segments, among different programs, and across multiple storage media. The computer-readable media may comprise a number of software modules. The software modules include instructions that, when executed by an apparatus such as a processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module, it will be understood that such functionality is implemented by the processor when executing instructions from that software module.

The following claims are not intended to be limited to the embodiments shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A method, comprising:
receiving input of a question from a first user in real time;
determining, based on the input, a quality of the question from a first set of content management algorithms;
prompting the first user with a notification for assistance in generating the question;
receiving a request from the first user for assistance;
generating a new question with a first generative model;
providing the generated question to the first user;
receiving confirmation from the first user to post the generated question; and
posting the generated question to a social computing environment.

2. The method of claim 1, wherein generating the new question with the first generative model comprises:
determining a set of answers corresponding to the question;
retrieving the set of answers corresponding the question; and
providing the set of answers corresponding to the question.

3. The method of claim 1, comprises:
receiving selection of the question from a second user;
receiving input of an answer from the second user; and
prompting the second user with a notification for assistance in generating the answer.

4. The method of claim 3, comprises:
receiving a request from the second user for assistance;
determining, based on the answer input, a quality of the answer from a second set of content management algorithms;
based on the answer input, generating a re-phrased answer with a second generative model;
providing the re-phrased answer to the second user;
receiving confirmation from the second user to post the re-phrased answer; and
posting the re-phrased answer to the social computing environment.

5. The method of claim 4, wherein the re-phrased answer can include a link to a previously generated answer in the social computing environment.

6. The method of claim 4, wherein each generative model is trained using data collected from the social computing environment with deep learning algorithms.

7. The method of claim 4, wherein:
the first set of content management algorithms includes a low-quality classifier, a misplaced question classifier, a garbage detection algorithm, and a homoglyph detection model; and
the second set of content management algorithms includes a spam detection algorithm, a garbage detection algorithm, an empty answer classifier, an unfinished answer classifier, and a phone number detection algorithm.

8. A system, comprising:
a processor; and
a memory storing instructions which when executed by the processor perform a method comprising:
receiving input of a question from a first user in real time;
determining, based on the input, a quality of the question from a first set of content management algorithms;
prompting the first user with a notification for assistance in generating the question;
receiving a request from the first user for assistance;
generating a new question with a first generative model;
providing the generated question to the first user;
receiving confirmation from the first user to post the generated question; and
posting the generated question to a social computing environment.

9. The system of claim 8, wherein generating the new question with the first generative model comprises:
determining a set of answers corresponding to the question;
retrieving the set of answers corresponding the question; and
providing the set of answers corresponding to the question.

10. The system of claim 8, wherein the method further comprises:
receiving selection of the question from a second user;
receiving input of an answer from the second user; and
prompting the second user with a notification for assistance in generating the answer.

11. The system of claim 10, wherein the method further comprises:
receiving a request from the second user for assistance;
determining, based on the answer input, a quality of the answer from a second set of content management algorithms;
based on the answer input, generating a re-phrased answer with a second generative model;
providing the re-phrased answer to the second user;
receiving confirmation from the second user to post the re-phrased answer; and
posting the re-phrased answer to the social computing environment.

12. The system of claim 11, wherein the re-phrased answer can include a link to a previously generated answer in the social computing environment.

13. The system of claim 11, wherein each generative model is trained using data collected from the social computing environment with deep learning algorithms.

14. The system of claim 11, wherein:
the first set of content management algorithms includes a low-quality classifier, a misplaced question classifier, a garbage detection algorithm, and a homoglyph detection model; and
the second set of content management algorithms includes a spam detection algorithm, a garbage detection algorithm, an empty answer classifier, an unfinished answer classifier, and a phone number detection algorithm.

15. A non-transitory computer-readable storage medium storing instructions for performing a method, the method comprising:
receiving input of a question from a first user in real time;
determining, based on the input, a quality of the question from a first set of content management algorithms;
prompting the first user with a notification for assistance in generating the question;
receiving a request from the first user for assistance;
generating a new question with a first generative model;
providing the generated question to the first user;
receiving confirmation from the first user to post the generated question; and
posting the generated question to a social computing environment.

16. The non-transitory computer-readable storage medium of claim 15, wherein generating the new question with the first generative model comprises:
determining a set of answers corresponding to the question;
retrieving the set of answers corresponding the question; and
providing the set of answers corresponding to the question.

17. The non-transitory computer-readable storage medium of claim 15, wherein the method further comprises:
receiving selection of the question from a second user;
receiving input of an answer from the second user; and
prompting the second user with a notification for assistance in generating the answer.

18. The non-transitory computer-readable storage medium of claim 17, wherein the method further comprises:
receiving a request from the second user for assistance;
determining, based on the answer input, a quality of the answer from a second set of content management algorithms;
based on the answer input, generating a re-phrased answer with a second generative model;
providing the re-phrased answer to the second user;
receiving confirmation from the second user to post the re-phrased answer; and
posting the re-phrased answer to the social computing environment.

19. The non-transitory computer-readable storage medium of claim 18, wherein each generative model is trained using data collected from the social computing environment with deep learning algorithms.

20. The non-transitory computer-readable storage medium of claim 18, wherein:
the first set of content management algorithms includes a low-quality classifier, a misplaced question classifier, a garbage detection algorithm, and a homoglyph detection model; and
the second set of content management algorithms includes a spam detection algorithm, a garbage detection algorithm, an empty answer classifier, an unfinished answer classifier, and a phone number detection algorithm.
